(19) United States
(12) Patent Application Publication
(10) Pub. No.: US 2026/0109205 A1
(43) Pub. Date: Apr. 23, 2026

(54) LIGHT ADJUSTING CONTROL APPARATUS

(71) Applicant: TOYOTA JIDOSHA KABUSHIKI KAISHA, Toyota-shi (JP)

(72) Inventor: Koji SUZUKI, Kariya-shi (JP)

(73) Assignee: TOYOTA JIDOSHA KABUSHIKI KAISHA, Toyota-shi (JP)

(21) Appl. No.: 19/349,534

(22) Filed: Oct. 3, 2025

(30) Foreign Application Priority Data
Oct. 21, 2024 (JP) 2024-185164

(51) Int. Cl. B60J 3/04

(52) U.S. Cl. CPC B60J 3/04

(57) ABSTRACT

A light adjusting control apparatus includes a light adjuster configured to adjust a transmittance of light incident on a window glass of a vehicle; an occupant state acquisition unit configured to acquire an eye position of an occupant of the vehicle; a face illuminance acquisition unit configured to acquire an illuminance of the light on a face of the occupant; and a light adjusting control unit configured to control the light adjuster based on the eye position and the illuminance. The light adjusting control unit changes at least one of a light adjusting position in the window glass at which the transmittance of the light is adjusted, and a degree of light adjustment which is a degree of adjusting the transmittance of the light, in response to a change in the illuminance at the eye position.

### CROSS-REFERENCE TO RELATED APPLICATION

This application claims the benefit of priority from Japanese Patent Application No. 2024-185164, filed on Oct. 21, 2024, the entire contents of which are incorporated herein by reference.

### TECHNICAL FIELD

The present disclosure relates to a light adjusting control apparatus.

### BACKGROUND

As a technique related to a light adjusting control apparatus in the related art, an apparatus is known that estimates a viewpoint position of a driver, and controls light-shielding means to shield light that is about to enter the driver's eyes through a windshield, based on a light source position and the viewpoint position (for example, Japanese Unexamined Patent Application Publication No. 2005-145219).

### SUMMARY

For example, in a vehicle that uses a board-shaped sun visor member, an occupant may manually adjust a position and an angle of the sun visor when a traveling direction of the vehicle changes. Considering such a situation, there is also room for improvement in a light adjusting control apparatus that controls a light adjuster that adjusts a transmittance of light incident on a window glass of the vehicle.

A light adjusting control apparatus according to one aspect of the present disclosure includes: a light adjuster configured to adjust a transmittance of light incident on a window glass of a vehicle; an occupant state acquisition unit configured to acquire an eye position of an occupant of the vehicle; a face illuminance acquisition unit configured to acquire an illuminance of the light on a face of the occupant; and a light adjusting control unit configured to control the light adjuster based on the eye position and the illuminance, wherein the light adjusting control unit changes at least one of a light adjusting position in the window glass at which the transmittance of the light is adjusted and a degree of light adjustment, which is a degree of adjusting the transmittance of the light, in response to a change in the illuminance at the eye position.

In the light adjusting control apparatus according to one aspect of the present disclosure, the light adjuster is controlled based on the eye position and the illuminance. At least one of the light adjusting position and the degree of light adjustment is changed in response to a change in the illuminance of the light at the eye position of the occupant of the vehicle. Here, when a direction of the vehicle with respect to a light source changes, a distribution of brightness and darkness of the illuminance of the light on the face of the occupant changes. Therefore, by controlling the light adjuster in response to the change in the illuminance of the light at the eye position of the occupant of the vehicle, it is possible to control the light adjuster in response to a change in the direction of the vehicle with respect to the light source. Accordingly, according to the light adjusting control apparatus of one aspect of the present disclosure, it is possible to control the light adjuster in response to a change in the direction of the vehicle with respect to the light source.

In some examples, the occupant state acquisition unit may acquire an opening degree value of at least one of a degree of opening of an eyelid of the occupant and a degree of opening of a pupil of the occupant, and the light adjusting control unit may change at least one of the light adjusting position and the degree of light adjustment when the light adjusting control unit estimates that the occupant is in a dazzled state based on a result of a comparison between the opening degree value and a predetermined opening degree threshold value.

In some examples, the light adjusting control unit may set the opening degree threshold value based on the opening degree value at a time when the light adjusting control unit estimates that the occupant is no longer in the dazzled state, after having estimated that the occupant was estimated to be in the dazzled state.

According to various aspects of the present disclosure, it is possible to control the light adjuster in response to a change in the direction of the vehicle relative to the light source.

### BRIEF DESCRIPTION OF THE DRAWINGS

FIG. 1 is a block diagram illustrating an example of a light adjusting control apparatus.

FIG. 2 is a schematic diagram of a vehicle interior illustrating an example arrangement of a light adjuster.

FIG. 3 is a schematic diagram illustrating an example of the light adjuster.

FIG. 4 is a schematic diagram illustrating an example of the light adjuster after a light adjusting position and a degree of light adjustment are changed.

FIG. 5 is a flowchart illustrating an example of processing of the ECU of FIG. 1.

FIG. 6 is a flowchart illustrating an example of the processing of FIG. 5 for estimating an occupant's dazzled state.

### DETAILED DESCRIPTION

Hereinafter, an example of the present disclosure will be described with reference to the drawings.

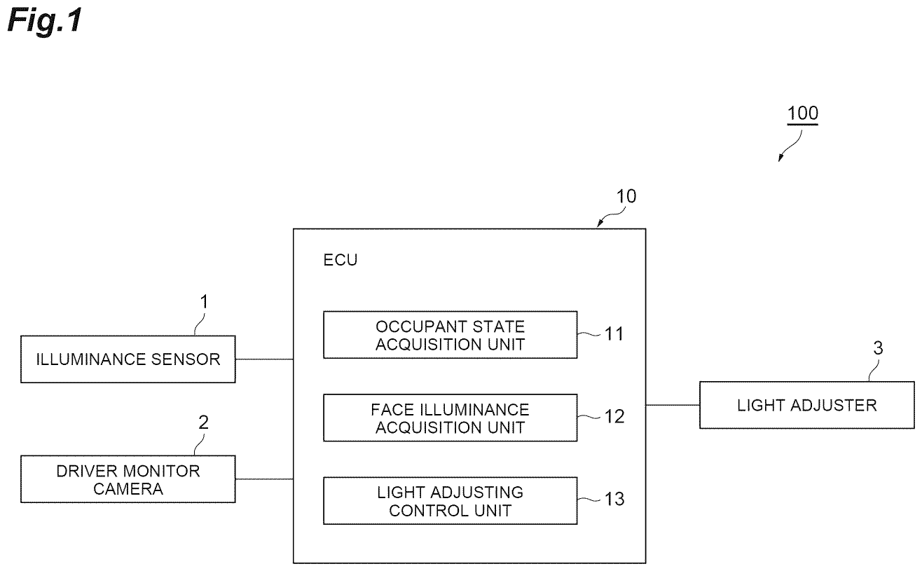

FIG. 1 is a block diagram illustrating an example of a light adjusting control apparatus. A light adjusting control apparatus 100 is an apparatus that controls a light adjuster that adjusts a transmittance of light incident on a window glass of a vehicle. The light adjusting control apparatus 100 is mounted on a vehicle such as a passenger car, for example.

### Configuration of Light Adjusting Control Apparatus

As shown in FIG. 1, the light adjusting control apparatus 100 includes an electronic control unit [ECU] 10. The ECU 10 is an electronic control unit having a central processing unit [CPU], a read only memory [ROM], a random access memory [RAM], a controller area network [CAN] communication circuit, and the like. In the ECU 10, for example, various functions are realized by loading a program stored in the ROM into the RAM and executing the program loaded in the RAM by the CPU. The ECU 10 may include a plurality of electronic units.

The ECU 10 is connected to an illuminance sensor 1, a driver monitor camera 2, and a light adjuster 3.

The illuminance sensor 1 is a sensor for acquiring an illuminance of light on a face of a driver (occupant). The illuminance sensor 1 is installed, for example, in an overhead module provided on a ceiling in a vehicle cabin of the vehicle, facing the face of the driver. The illuminance sensor 1 detects, for example, the illuminance on the surface of the driver's face illuminated by light. As the illuminance in this case, a physical quantity in units of lux can be used. The illuminance sensor 1 transmits detected illuminance information to the ECU 10.

The driver monitor camera 2 is a camera for imaging the face of the driver. The driver monitor camera 2 is provided, for example, on a cover of a steering column of the vehicle, facing the driver's face. A plurality of driver monitor cameras 2 may be provided to image the driver from a plurality of directions. The driver monitor camera 2 transmits a captured image of the driver to the ECU 10.

The light adjuster 3 is a member that adjusts the transmittance of light incident on a windshield 52 (window glass) of the vehicle 50. The light adjuster 3 is, for example, a light adjusting glass or a light adjusting film. The light adjusting glass or the light adjusting film may include a film-shaped member that controls the transmittance of light using liquid crystal or the like. The light adjuster 3 may include a liquid crystal cell, a polarizing plate including a polarizer, a polarizing plate protection film adjacent to the polarizer, and the like. As the light adjuster 3, other known components that can adjust the transmittance of incident light in response to a control signal from the ECU 10 can be used.

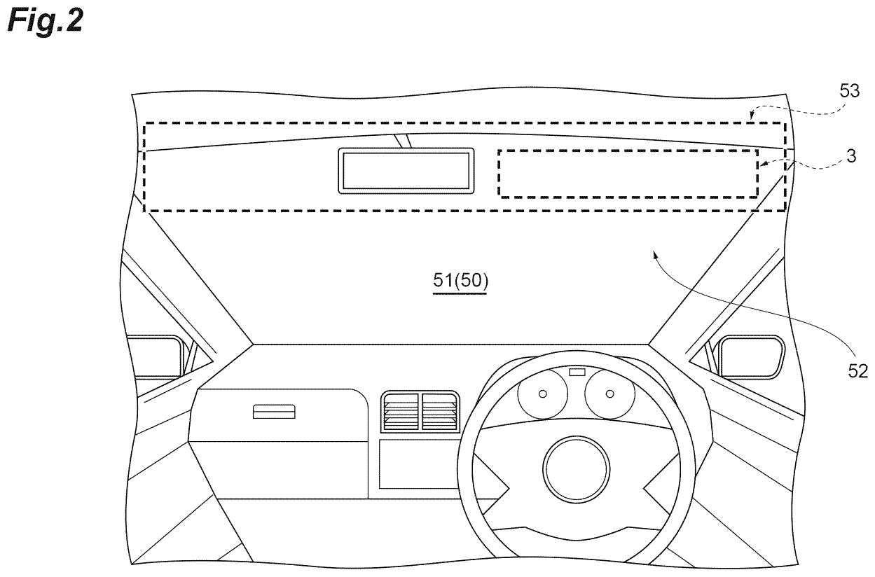

FIG. 2 is a schematic diagram of a vehicle interior illustrating an arrangement example of the light adjuster. FIG. 2 illustrates, as an example, the windshield 52 and the light adjuster 3 in a vehicle cabin space 51 of the vehicle 50. As shown in FIG. 2, the light adjuster 3 in this example is arranged in an upper edge region 53 of the windshield 52. The upper edge region 53 is a range in the windshield 52 within, for example, 20% of an entire vertical dimension of the windshield 52 from an upper edge of the windshield 52. The light adjuster 3 is arranged on a driver side (here, a right side) in the windshield 52 included in the upper edge region 53. When the vehicle 50 is a left-hand drive vehicle, the light adjuster 3 may be arranged on a left side in the windshield 52 included in the upper edge region 53.

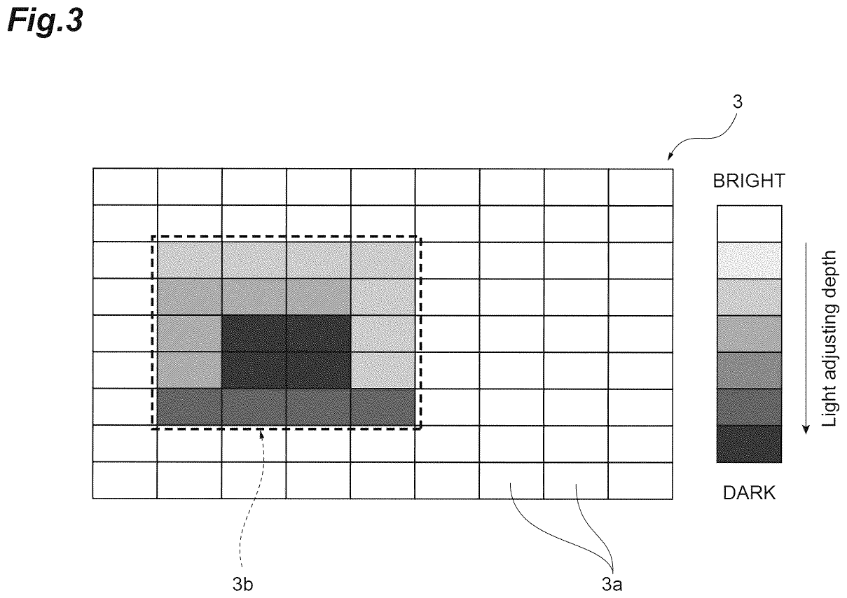

FIG. 3 is a schematic diagram illustrating an example of the light adjuster. FIG. 3 schematically illustrates the light adjuster 3 as viewed from the driver. As shown in FIG. 3, the light adjuster 3 is formed of, for example, a plurality of segments 3a arranged in a matrix. A shape of each segment 3a is a rectangle in the example of FIG. 3. The shape of each segment 3a is not limited to this example. The shape of each segment 3a may be, for example, a hexagon, a trapezoid, a parallelogram, a triangle, or the like. Each segment 3a can independently adjust the transmittance of light. Each segment 3a can adjust light to a plurality of stages of a light adjusting depth (degree of light adjustment) by changing the transmittance of light in stages in response to a control signal from the ECU 10.

Next, a functional configuration of the ECU 10 will be described. The ECU 10 has an occupant state acquisition unit 11, a face illuminance acquisition unit 12, and a light adjusting control unit 13. A part of the functions of the ECU 10 described below may be executed in a server communicable with the vehicle 50.

The occupant state acquisition unit 11 acquires an eye position of the driver of the vehicle 50 based on the captured image of the driver monitor camera 2. The occupant state acquisition unit 11 specifies, for example, a position of a pupil of an eye of the driver as the eye position based on known image processing using the captured image of the driver monitor camera 2. The occupant state acquisition unit 11 may acquire the eye position of the driver as three-dimensional coordinates in a vehicle interior coordinate system.

The occupant state acquisition unit 11 may acquire an opening degree value of at least one of a degree of opening of an eyelid of the driver and a degree of opening of a pupil of the driver. The degree of opening of the eyelid is an index representing a degree of opening of the eyelid, and can be, for example, a ratio of an eyelid distance. A numerator of the ratio of the eyelid distance may be, for example, a distance between an upper eyelid and a lower eyelid of the driver calculated based on known image processing using the captured image of the driver monitor camera 2. A denominator of the ratio of the eyelid distance may be, for example, a value of the degree of opening of the eyelid set in advance based on a result of a preliminary test for a plurality of subjects. The degree of opening of the pupil is an index representing a degree of opening of the pupil, and can be, for example, a pupil diameter. The pupil diameter may be calculated, for example, based on known image processing using an captured image of the driver monitor camera 2.

The face illuminance acquisition unit 12 acquires the illuminance on the driver's face based on the illuminance information of the illuminance sensor 1. The face illuminance acquisition unit 12 acquires the illuminance of the light at each part along a surface of the face of the driver based on known image processing using the captured image of the driver monitor camera 2. The face illuminance acquisition unit 12 may acquire, for example, the illuminance at each position of the face of the driver in a three-dimensional coordinate system in the vehicle interior coordinate system.

The light adjusting control unit 13 controls the light adjuster 3 based on the eye position and the illuminance. The light adjusting control unit 13 changes, for example, at least one of a light adjusting position and a light adjusting depth of the light adjuster 3 in response to a change in the illuminance at the eye position of the driver. The light adjusting position is a position in the windshield 52 at which the transmittance of the light is adjusted using the light adjuster 3. The light adjusting position corresponds to, for example, the position of each segment 3a in the light adjuster 3. The light adjusting depth is a degree of adjusting the transmittance of the light. The light adjusting depth can be changed for each light adjusting position according to specifications of the light adjuster 3.

The light adjusting control unit 13 may estimate whether or not the driver is in a dazzled state. The dazzled state means a state in which the driver feels glare. The dazzled state can be considered a state in which reducing the illuminance at the eye position is beneficial for the driver.

The light adjusting control unit 13 estimates that the driver is in the dazzled state, for example, when the illuminance at the eye position is equal to or greater than an illuminance threshold value. The illuminance threshold value is a threshold value for determining whether or not to reduce the illuminance at the eye position. The illuminance threshold value may be, for example, a value of illuminance set in advance based on a result of a preliminary test for a plurality of subjects.

The light adjusting control unit 13 may estimate that the driver is in the dazzled state based on a result of a comparison between an opening degree value of at least one of the degree of opening of the eyelid and the degree of opening of the pupil of the driver acquired by the occupant state acquisition unit 11 and a predetermined opening degree threshold value. The opening degree threshold value is a threshold value for estimating whether or not the driver is in the dazzled state. The opening degree threshold value includes at least one of a threshold value of the degree of opening of the eyelid and a threshold value of the degree of opening of the pupil, so as to correspond to at least one of the degree of opening of the eyelid and the degree of opening of the pupil of the driver acquired by the occupant state acquisition unit 11. The opening degree threshold value may be, for example, a value of the degree of opening of the eyelid and the pupil set in advance based on a result of a preliminary test for a plurality of subjects.

When, based on a result of a comparison between the opening degree value of at least one of the degree of opening of the eyelid and the degree of opening of the pupil and the predetermined opening degree threshold value, the light adjusting control unit 13 estimates that the driver is no longer in the dazzled state after having estimated that the driver was in the dazzled state, the light adjusting control unit 13 may set the opening degree threshold value based on the opening degree value of the degree of opening of the eyelid or the degree of opening of the pupil. When it is estimated that the driver is no longer in the dazzled state after having been estimated to be in the dazzled state, it can be considered that the driver no longer feels glare. Therefore, the light adjusting control unit 13 updates the opening degree threshold value with the opening degree value of the degree of opening of the eyelid or the degree of opening of the pupil in a state where the driver does not feel glare. Accordingly, the opening degree threshold value is set to a real-time value in response to the state of the driver.

When the light adjusting control unit 13 estimates that the driver is in the dazzled state, the light adjusting control unit 13 changes at least one of the light adjusting position and the light adjusting depth so as to reduce the illuminance at the eye position. When the light adjusting control unit 13 estimates that the driver is not in the dazzled state, the light adjusting control unit 13 maintains the light adjusting position and the light adjusting depth.

FIG. 3 is a schematic diagram illustrating an example of the light adjuster 3 before the light adjusting position and the degree of light adjustment are changed. In FIG. 3, for example, light is incident from diagonally front left of the driver with respect to a traveling direction of the vehicle 50. As shown in FIG. 3, in the light adjuster 3, a light adjusting depth of a plurality of segments 3a is reduced in a light adjusting region 3b. The light adjusting control unit 13 may reduce the light adjusting depth of the plurality of segments 3a as an initial state based on the illuminance at the eye position. As an initial state, the light adjusting control unit 13 may separately calculate a line-of-sight direction from the eye position of the driver and a light source direction of the light, and reduce the light adjusting depth of the plurality of segments 3a based on the line-of-sight direction and the light source direction.

In the state of FIG. 3, light is shielded by the segments 3a with a dark light adjusting depth in the light adjusting region 3b. By such segments 3a with the dark light adjusting depth, a light-shielded portion where the illuminance is low is formed at the position corresponding to the eye position on the face of the driver.

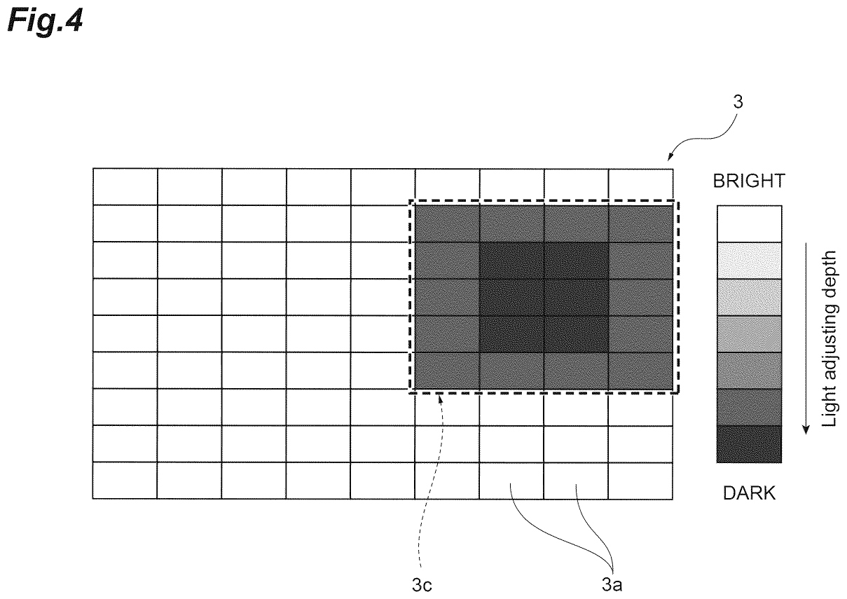

Next, FIG. 4 is a schematic diagram illustrating an example of the light adjuster 3 after the light adjusting position and the degree of light adjustment are changed. The example of FIG. 4 corresponds to a state in which the traveling direction of the vehicle 50 has changed from the state of FIG. 3, and the light that was incident from diagonally front left of the driver is now incident from diagonally front right of the driver. That is, the direction of the vehicle 50 with respect to the sun as a light source has changed.

As shown in FIG. 4, a position of the plurality of segments 3a in which the light adjusting depth is reduced has moved from the light adjusting region 3b to a light adjusting region 3c. To be more specific, first, assuming that a direction of incident light changes in response to a change in the traveling direction of the vehicle 50 while maintaining the state of FIG. 3, the light-shielded portion where the illuminance is low on the face of the driver moves so as to be displaced from the position corresponding to the eye position. When the light-shielded portion is displaced from the position corresponding to the eye position, the opening degree value of at least one of the degree of opening of the eyelid and the degree of opening of the pupil of the driver becomes larger than the predetermined opening degree threshold value, and the light adjusting control unit 13 estimates that the driver is in the dazzled state.

In response to estimating that the driver is in the dazzled state, the light adjusting control unit 13 changes the light adjusting positions of the plurality of segments 3a based on the eye position of the driver and the illuminance at each position of the face of the driver, such that the light-shielded portion where the illuminance is low on the face of the driver approaches the eye position of the driver. At this time, the light adjusting control unit 13 changes the light adjusting position, for example, without changing the light adjusting depth of the plurality of segments 3a. The light adjusting control unit 13 may change the light adjusting position while changing the light adjusting depth of the plurality of segments 3a. The light adjusting control unit 13 repeatedly changes the light adjusting position until the light-shielded portion overlaps the eye position of the driver.

In a state where the light-shielded portion overlaps the eye position of the driver, when the opening degree value of at least one of the degree of opening of the eyelid and the degree of opening of the pupil is larger than the predetermined opening degree threshold value, the light adjusting control unit 13 may change the light adjusting depth in the light adjusting region 3c to be darker until the opening degree value of the degree of opening of the eyelid and the degree of opening of the pupil becomes equal to or smaller than the predetermined opening degree threshold value. In the example of FIG. 4, compared to the light adjusting region 3b of FIG. 3, the light adjusting depth is darker over a wide range in the light adjusting region 3c. Accordingly, even when the incident direction of the light changes in response to a change in the traveling direction of the vehicle 50, the illuminance with respect to the eye position of the driver is adjusted, and the dazzled state of the driver is reduced.

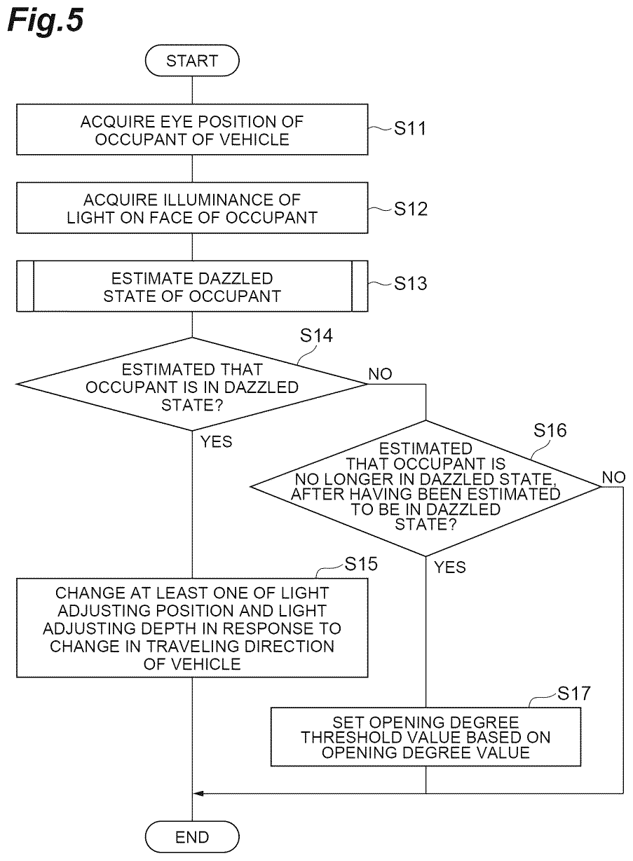

Next, an example of calculation processing by the light adjusting control apparatus 100 will be described. FIG. 5 is a flowchart illustrating an example of processing of the ECU 10. The processing of the flowchart shown in FIG. 5 is executed, for example, when power of the ECU 10 is on.

In S11, the ECU 10 of the light adjusting control apparatus 100 acquires the eye position of the driver of the vehicle by the occupant state acquisition unit 11. The occupant state acquisition unit 11 acquires the eye position of the driver of the vehicle 50 based on the captured image of the driver monitor camera 2.

In S12, the ECU 10 acquires the illuminance of the light on the face of the driver by the face illuminance acquisition unit 12. The face illuminance acquisition unit 12 acquires the illuminance of the light at each part along a surface of the face of the driver based on known image processing using the captured image of the driver monitor camera 2.

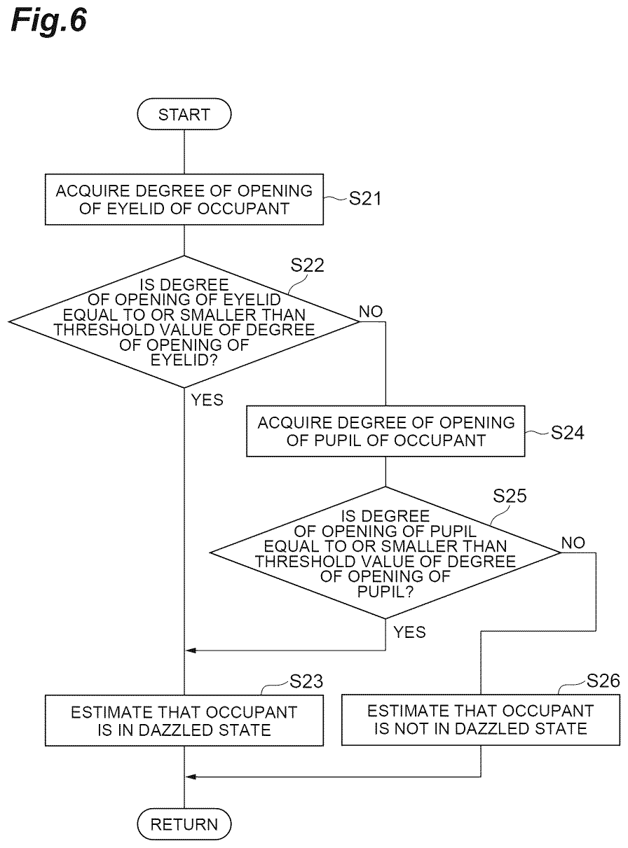

In S13, the ECU 10 performs estimation of the dazzled state of the driver. The ECU 10 performs, for example, processing shown in FIG. 6 as the estimation processing of the dazzled state in S13.

FIG. 6 is a flowchart illustrating an example of the processing of FIG. 5 for estimating an occupant's dazzled state. The processing of the flowchart shown in FIG. 6 is executed, for example, when power of the ECU 10 is on.

In S21, the ECU 10 acquires the degree of opening of the eyelid of the driver by the occupant state acquisition unit 11. The occupant state acquisition unit 11 acquires, for example, the degree of opening of the eyelid of the driver based on known image processing using the captured image of the driver monitor camera 2.

In S22, the ECU 10 determines whether or not the degree of opening of the eyelid is equal to or smaller than a threshold value of the degree of opening of the eyelid by the light adjusting control unit 13. When it is determined that the degree of opening of the eyelid is equal to or smaller than the threshold value of the degree of opening of the eyelid (S22: YES), in S23, the ECU 10 estimates that the driver is in the dazzled state by the light adjusting control unit 13. Thereafter, the ECU 10 ends the calculation processing of FIG. 6 and returns to the processing of S14 of FIG. 5.

On the other hand, when it is determined that the degree of opening of the eyelid is larger than the threshold value of the degree of opening of the eyelid (S22: NO), the ECU 10 proceeds to processing of S24. In S24, the ECU 10 acquires the degree of opening of the pupil by the occupant state acquisition unit 11. The occupant state acquisition unit 11 acquires, for example, the degree of opening of the pupil of the driver based on known image processing using the captured image of the driver monitor camera 2.

In S25, the ECU 10 determines whether or not the degree of opening of the pupil is equal to or smaller than a threshold value of the degree of opening of the pupil by the light adjusting control unit 13. When it is determined that the degree of opening of the pupil is equal to or smaller than the threshold value of the degree of opening of the pupil (S25: YES), in S23, the ECU 10 estimates that the driver is in the dazzled state by the light adjusting control unit 13. Thereafter, the ECU 10 ends the calculation processing of FIG. 6 and returns to the processing of S14 of FIG. 5.

On the other hand, when it is determined that the degree of opening of the pupil is larger than the threshold value of the degree of opening of the pupil (S25: NO), the ECU 10 proceeds to processing of S26. In S26, the ECU 10 estimates that the driver is not in the dazzled state by the light adjusting control unit 13. Thereafter, the ECU 10 ends the calculation processing of FIG. 6 and returns to the processing of S14 of FIG. 5.

Returning to FIG. 5, in S14, the ECU 10 determines whether or not it has been estimated that the driver is in the dazzled state by the light adjusting control unit 13.

When it is estimated that the driver is in the dazzled state (S14: YES), in S15, the ECU 10 changes at least one of the light adjusting position and the light adjusting depth in response to a change in the traveling direction of the vehicle by the light adjusting control unit 13. For example, the light adjusting control unit 13 changes the light adjusting position of the plurality of segments 3a based on the eye position of the driver and the illuminance at each position of the face of the driver, such that the light-shielded portion where the illuminance is low on the face of the driver approaches the eye position of the driver. In a state where the light-shielded portion overlaps the eye position of the driver, the light adjusting control unit 13 may change the light adjusting depth in the light adjusting region 3c to be darker. Thereafter, the ECU 10 ends the calculation processing of FIG. 5. The ECU 10 may repeat the calculation processing of FIG. 5 at predetermined time intervals.

On the other hand, when it is estimated that the driver is not in the dazzled state (S14: NO), the ECU 10 proceeds to processing of S16. In S16, the ECU 10 determines whether or not it has been estimated that the driver is no longer in the dazzled state, after having been estimated to be in the dazzled state, by the light adjusting control unit 13.

When it is estimated that the driver is no longer in the dazzled state after having been estimated to be in the dazzled state (S16: YES), in S17, the ECU 10 sets the opening degree threshold value based on the opening degree value by the light adjusting control unit 13. The light adjusting control unit 13 updates the opening degree threshold value with the opening degree value of the degree of opening of the eyelid or the degree of opening of the pupil in a state where the driver does not feel glare. Thereafter, the ECU 10 ends the calculation processing of FIG. 5. The ECU 10 may repeat the calculation processing of FIG. 5 at predetermined time intervals.

On the other hand, when it is estimated that the driver is not in a state of no longer being in the dazzled state after having been estimated to be in the dazzled state (S16: NO), the ECU 10 maintains the light adjusting position and the light adjusting depth by the light adjusting control unit 13. Thereafter, the ECU 10 ends the calculation processing of FIG. 5. The ECU 10 may repeat the calculation processing of FIG. 5 at predetermined time intervals.

According to the light adjusting control apparatus 100 described above, the light adjuster 3 is controlled based on the eye position and the illuminance. At least one of the light adjusting position and the light adjusting depth is changed in response to a change in the illuminance of the light at the eye position of the driver of the vehicle 50. Here, when the traveling direction of the vehicle 50 changes, a distribution of brightness and darkness of the illuminance of the light on the face of the driver changes. Therefore, by controlling the light adjuster 3 in response to the change in the illuminance of the light at the eye position of the driver of the vehicle 50, it is possible to control the light adjuster 3 in response to a change in the traveling direction of the vehicle 50. Accordingly, according to the light adjusting control apparatus 100, it is possible to control the light adjuster 3 in response to a change in the traveling direction of the vehicle 50.

In the light adjusting control apparatus 100, the occupant state acquisition unit 11 acquires the opening degree value of at least one of the degree of opening of the eyelid of the driver and the degree of opening of the pupil of the driver. When the light adjusting control unit 13 estimates that the driver is in a dazzled state based on a result of a comparison between the opening degree value and a predetermined opening degree threshold value, the light adjusting control unit 13 changes at least one of the light adjusting position and the light adjusting depth. Accordingly, using at least one of the degree of opening of the eyelid of the driver and the degree of opening of the pupil of the driver, at least one of the light adjusting position and the light adjusting depth can be changed in response to whether or not the driver feels glare.

In the light adjusting control apparatus 100, the light adjusting control unit 13 sets the opening degree threshold value based on the opening degree value at a time when the light adjusting control unit 13 estimates that the driver is no longer in the dazzled state, after having estimated that the driver was in the dazzled state. Accordingly, the opening degree threshold value is updated with the opening degree value of the degree of opening of the eyelid or the degree of opening of the pupil in a state where the driver does not feel glare. Therefore, the opening degree threshold value can be set to a real-time value in response to the state of the driver.

### Modifications

The present disclosure is not limited to the example described above. The present disclosure can be carried out in various forms with various changes and improvements based on the knowledge of those skilled in the art, including the example described above.

In the example described above, the windshield 52 of the vehicle 50 is illustrated as the window glass of the vehicle, but the present disclosure is not limited to this example. For example, the window glass of the vehicle may be a ceiling glass provided on a roof of the vehicle. In this case, while the vehicle is parked, by executing processing similar to the processing for the driver described above for the driver in a reclining state with a backrest of a driver's seat laid down, it is possible to suppress the driver from feeling glare even when a change occurs between a direction with respect to the sun as a light source and a front-rear direction of the parked vehicle due to, for example, an elapse of time or a change in a parking position. That is, the change in the direction of the vehicle with respect to the light source is not limited to the change in the traveling direction of the vehicle.

In the example described above, the opening degree threshold value is updated to a real-time value in response to the state of the driver, but this example may be omitted. The opening degree threshold value may be constant at a predetermined value set in advance.

In the example described above, the light adjusting control unit 13 estimates whether or not the driver is in the dazzled state using at least one of the degree of opening of the eyelid of the driver and the degree of opening of the pupil of the driver, but the present disclosure is not limited to this example. Estimating whether or not the driver is in the dazzled state itself may be omitted.

In the example described above, the light adjusting control unit 13 changes the light adjusting position so as to move the plurality of segments 3a in which the light adjusting depth is darkened, such that the light-shielded portion where the illuminance is low on the face of the driver approaches the eye position of the driver, but the present disclosure is not limited to this example. The light adjusting control unit 13 may substantially change the light adjusting position by changing the light adjusting depth of a plurality of segments 3a at a position corresponding to the eye position of the driver to be darker so that a light-shielded portion is generated at the eye position of the driver. In this case, the light adjusting control unit 13 may specify the segments 3a for which the light adjusting depth is to be changed, based on a position of the segments 3a before the change of the light adjusting depth, the eye position of the driver, and a change in the illuminance on the face of the driver.

In the example described above, the illuminance of the light on the face of the driver is acquired using the illuminance sensor 1, but the present disclosure is not limited to this example. The illuminance of the light on the face of the driver may be acquired based on known image processing using the captured image of the driver monitor camera 2.

In the example described above, the driver is illustrated as the occupant, but the present disclosure is not limited to this example. The occupant may be an occupant other than the driver.

In the example described above, an example is shown in which a change in the traveling direction of the vehicle 50 is not directly acquired using a change in the distribution of brightness and darkness of the illuminance of the light on the face of the driver, but the change in the traveling direction of the vehicle 50 may be directly acquired. In this case, for example, the change in the traveling direction of the vehicle may be directly acquired based on information such as a change in a vehicle position measured using a GNSS receiving unit, or a detection result of a yaw rate sensor. The light adjusting control unit may change at least one of the light adjusting position and the degree of light adjustment in response to the acquired change in the traveling direction of the vehicle.

What is claimed is:

1. A light adjusting control apparatus, comprising:
a light adjuster configured to adjust a transmittance of light incident on a window glass of a vehicle;
an occupant state acquisition unit configured to acquire an eye position of an occupant of the vehicle;
a face illuminance acquisition unit configured to acquire an illuminance of the light on a face of the occupant; and
a light adjusting control unit configured to control the light adjuster based on the eye position and the illuminance,
wherein the light adjusting control unit changes at least one of a light adjusting position in the window glass at which the transmittance of the light is adjusted, and a degree of light adjustment which is a degree of adjusting the transmittance of the light, in response to a change in the illuminance at the eye position.

2. The light adjusting control apparatus according to claim 1,
wherein the occupant state acquisition unit acquires an opening degree value of at least one of a degree of opening of an eyelid of the occupant and a degree of opening of a pupil of the occupant, and
wherein the light adjusting control unit changes at least one of the light adjusting position and the degree of light adjusting when the light adjusting control unit estimates that the occupant is in a dazzled state based on a result of a comparison between the opening degree value and a predetermined opening degree threshold value.

3. The light adjusting control apparatus according to claim 2,
wherein the light adjusting control unit sets the opening degree threshold value based on the opening degree value at a time when the light adjusting control unit estimates that the occupant is no longer in the dazzled state, after having estimated that the occupant was estimated to be in the dazzled state.
